(19) United States
(12) Patent Application Publication
(10) Pub. No.: US 2023/0029278 A1
(43) Pub. Date: Jan. 26, 2023

(54) EFFICIENT EXPLORER FOR RECORDED MEETINGS

(71) Applicant: EMC IP Holding Company LLC, Hopkinton, MA (US)

(72) Inventors: Anat Parush Tzur, Beer Sheva (IL); Amihai Savir, Sansana (IL); Or Herman-Saffar, Ofakim (IL)

(21) Appl. No.: 17/443,113

(22) Filed: Jul. 21, 2021

(51) Int. Cl. G06F 16/732; G06F 16/738

(52) U.S. Cl. CPC G06F 16/7328; G06F 16/738

(57) ABSTRACT

One example method includes generating a searchable video library. Video files are processed to extract text corresponding to the speech and to the images. The extracted text is semantically searched such that specific portions or locations of video files can be identified and returned in response to a query.

### FIELD OF THE INVENTION

Embodiments of the present invention generally relate to data management including video searching operations. More particularly, at least some embodiments of the invention relate to systems, hardware, software, computer-readable media, and methods for searching or exploring data including video data and/or audio data.

### BACKGROUND

Virtual meetings have many advantages. Virtual meetings allow people to meet and collaborate without having to be present in the same physical location. In addition, virtual meetings can be saved as video data. Once saved, the content of saved video files can be accessed and shared as desired. The video files corresponding to virtual meetings become a valuable resource.

However, the ability to effectively use this resource is lacking. For example, many users often want to review a concept or detail that was discussed during a previous meeting. Unfortunately, the users may not be able to remember the specific meeting or point in time in the meeting when the concept or detail was discussed. Thus, even though the data desired by a user exists, accessing that data is much more difficult.

Manually searching a folder of video files is costly and time consuming and ineffective. In fact, most users do not even try because they do not have the time to review multiple video files to find a specific video segment where a particular detail or concept was discussed.

A few technologies exist that allow a user to search for an object within a video or that convert a video's audio into a transcript that can be searched. These approaches, however, have several limitations. For example, it is necessary to use the same terms that were used in the meeting. A user that cannot remember the specific terms used in the meeting may not have a successful search. In addition, these searches can consume significant time.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of an explorer engine configured to generate a searchable video library and configured to execute searches of the library;

FIG. 2 discloses aspects of an explorer engine configured to generate and use a searchable video library;

FIG. 3A discloses aspects of generating a searchable video library including processing image aspects of video files;

FIG. 3B discloses aspects of processing images in a video file; and

FIG. 4 discloses aspects of a natural language processing engine.

### DETAILED DESCRIPTION OF SOME EXAMPLE EMBODIMENTS

Embodiments of the present invention generally relate to data management operations including searching or exploring files such as video and/or audio files. More particularly, at least some embodiments of the invention relate to systems, hardware, software, computer-readable media, and methods for searching or exploring video files and preparing video files to be searched or explored.

Embodiments of the invention more specifically relate to semantically searching a video library and/or to generating a video library that can be semantically searched. To semantically search a video library, the video and audio or speech portions of the video file are processed to generate searchable data or to generate data that can be semantically compared to a query.

More specifically, embodiments of the invention process the audio or speech portion of a video file (or associated with an audio file) to convert speech to text and generate a transcript database that associates text with speaker and with timestamps. The image portion of the video file (e.g., objects, documents shared in the video, other objects or text represented graphically or visually as images) is processed such that the image content is represented textually in an image text database.

Embodiments of the invention may also employ or include a NLP (Natural Language Processing) engine that allows the transcript database and the image text database to be semantically searched or semantically interpreted. In one example, a video file can be auto partitioned into multiple topics or segments and made semantically searchable. The ability to effectively search video files can increase the productivity of an organization including with regard to sales calls with customers, meetings with designers, engineering, finance, development, education, and more. Embodiments of the invention allow any recorded video to be searched for a specific detail or concept that mas mentioned vocally or visually. Embodiments of the invention, in response to a query, may identify a specific portion of a specific video file. For example, a portion of a video file (e.g., the location of a relevant clip in a video file) may be returned or identified in response to the query.

For example, a company may conduct online meetings using available known applications. These meetings can be recorded and stored and shared. Embodiments of the invention allow these recorded meetings, which are examples of video data or video files, to be searched or explored. Advantageously, embodiments of the invention allow these video files to be semantically searched. Semantically searching includes searching for content based on meaning rather than a literal match to the input.

Embodiments of the invention may use speech recognition to convert audio or speech to text and/or perform speaker recognition/identification. This allows the text of a video file resulting from speech recognition to be indexed according to time and by speaker. This allows to also be performed by speaker.

Image processing may be used to perform image recognition and/or smart OCR (optical character recognition). This allows images or data appearing in a video file (e.g., images, text, slides, documents, or other data shared in an online meeting) in an image form to be represented as or converted to text. As a result, images (e.g., frames or groups of frames) or content included in those images appearing in the video file can be effectively converted to text and made searchable and indexed. Embodiments of the invention may be performed in real time (e.g., as an online meeting is being conducted) or by post-processing the video files generated after the meeting concludes. Embodiments of the invention may also be used on existing video files. Any video data or file can be processed in accordance with embodiments of the invention.

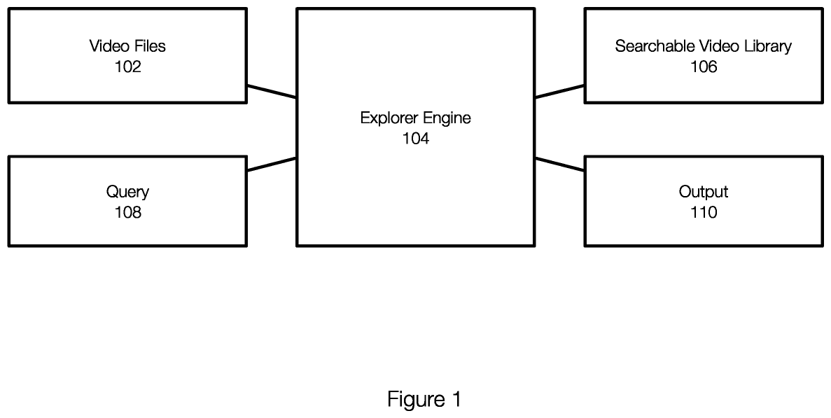

FIG. 1 discloses aspects of an explorer engine configured for exploring or searching video files and/or preparing a video library used in searching video files. In one example, video files 102 are input into or accessed by an explorer engine 104. The explorer engine 104 processes the video files to generate a searchable video library 106. The searchable video library may include databases such as text databases (e.g., text generated from processing a video file's audio content and text generated from processing a video file's image or video content). The databases in the searchable video library may be indexed to a video file and corresponding timestamps. This allows specific portions or specific locations of specific video files to be identified and returned in response to a query. The video library 106 can be updated with new content as the content becomes available.

Once the video library 106 is prepared, a query 108 may be received by the explorer engine 104 on the searchable video library 106. The explorer engine 104 executes a search and may return an output 110 that includes results of the query. The output 110 may identify segments of a video file that are semantically close to the query

The explorer engine 104 may include a server computer and other computing hardware. The explorer engine 104 may be implemented in virtual machines, containers, and the like. The explorer engine 104 may be accessed over a network such as the Internet, a local area network, or the like. The searchable video library 106 and the video files 102 may be stored together, separately, independently or the like on one or more storage devices. The storage devices may be local or cloud-based.

In one example, the generation of the video library 106 can be performed independently of searching the video library. The explorer engine 104 can be adapted to perform these tasks together or separately.

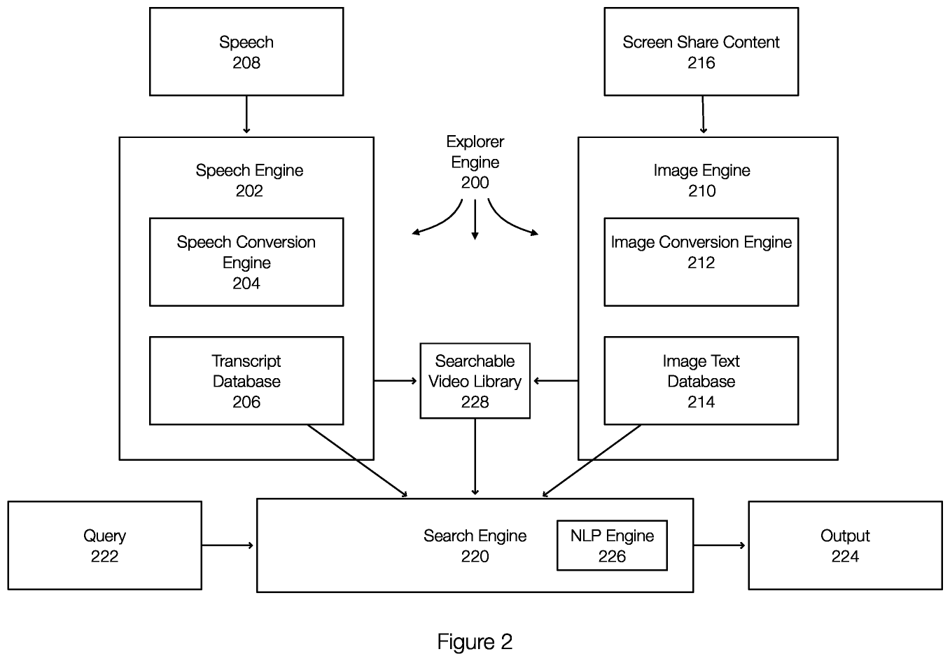

FIG. 2 discloses aspects of an explorer engine configured for generating a searchable video library and/or exploring or searching files including video files. FIG. 2 illustrates an explorer engine 200 (an example of the explorer engine 104) that is configured for processing video files and/or searching video files that have been processed for searching. Processing the video files for searching includes, by way of example and not limitation, processing the speech or audio included in the video files and processing images or shared content that may appear in the video files.

For example, the explorer engine 200 may include a speech engine 202. The speech engine 202 receives, as input, speech 208 included in the video file or extracted from the video file. The speech engine 202 may include or have access to a speech conversion engine 204 that converts the speech to text. The speech conversion engine 204 may also associate the text with a specific speaker and a time stamp. The information output by the speech conversion engine 204 may be referred to as a transcript. Thus, a transcript for a video file may include text of the speech, speaker recognition (who said what text) and/or timing information or the like.

In one example, an online meeting application that facilitates online meetings and generates recordings thereof may create an audio transcription on the fly and include both speaker detection and timestamping information. Thus, a text version of the speech and associations between speech, speaker, and time may already be available. This information may simply be retrieved from the video file being processed. However, if this information is not readily available, the video file can be processed to extract text of any speech or audio in the video file, speaker identification, and timestamping. For example, a python package such as https://pypi.org/project/SpeechRecognition may perform audio to text, speaker recognition, and correlate textual context with time. In some examples, punctuation may be removed from this type of data. A model such as https://pypi.org/project/punctuator/ may be used to restore punctuation to unsegmented text.

In this example, the speech conversion engine 204 may output a transcript (or text) to a transcript database 206 or other storage structure that allows the speech of a video file to be searched based on text, speaker, and/or time. In one example, a search for text may generate results that identify locations in or clips of video files that satisfy the parameters of the search. The results may be links to the relevant video files or to specific locations in the relevant video files. The results may identify, for example, video 23 at time 24:13. The results may alternatively indicate a time period that satisfies the search such as video 23 between 23:10 and 24:20.

Alternatively, the video file may be segmented and a specific segment may be identified. If the video has been parsed (e.g., by subject based on associated texts or in another manner), a video portion or link thereto may be provided.

The explorer engine 200 may also include an image engine 210. Generally, the image engine 210 is configured to perform at least image recognition and smart OCR. The image engine 210 may include an image conversion engine 212 that generates text from images in the video stream, which text is stored in an image text database 214. For example, a user may display a word processing document or a slide (e.g., shared content). The text in this document or slide is OCR'd to generate text representing the image content shared in the video file, but represented as an image.

In one example, a database such as the searchable video library 228 may be constructed to store text of the text generated when processing multiple video files. Thus, a user can search for a specific video file or for specific content amongst a plurality of video files included in or represented in the searchable video library 228.

A query 222 by a user, for example, may be input to search engine 220, which is part of the explorer engine 200. The search engine 220 may include an NLP engine 226. The query 222, which may include text, is used to search the transcript database 206 and/04 the image text database 214. Stated differently, the query 222 is used to identify text extracted from the video files that is semantically similar to the query 222. The query 222 can be directed to the text associated with a specific video file and/or to the text associated with multiple video files.

More specifically, a query 222 may be entered into a user interface associated with the NLP engine 226. The NLP engine 226 may search the transcript database 206 and the image text database 214 to generate an output 223. The output 224 may include a list of videos and locations in the list of video files that satisfy the query or that best match the query. In one example, a user can identify which of the results in the output 224 is best and this input can be used to improve the operation of identifying results that satisfy the query 222.

More specifically, the video files represented in the searchable video library 228 may be divided into segments. The transcript of a video file may be divided into short segments (each segment may be a sentence or a few sentences). Similarly, the image aspect of the video file may be segmented such that text is associated with each segment. The search engine 220 may employ the NLP engine 226 to determine whether the query 222 is semantically similar to any of these segments.

For example, if the query is “the cat chased the mouse” and the text in the transcript is “the mouse was chased by the cat”, the NLP engine 226 may indicate a match or indicate that the text in the transcript is semantically similar to the query. If another portion of the text in the transcript is “the cat was chased by the dog”, the output may be that no semantic similarity or insufficient similarity is present. By comparing the query to all segments, a list of potential answers to the query can be generated. These answers or results of the query 222 can be scored and a list of potential answers can be provided to the user.

More generally, a video file may be divided into sections where each section includes a sentence or a few words of text. The NLP engine 220 may determine a meaning for this text. A query can be similarly processed such that the sections of the video file that best match or that are most semantically similar to the query can be identified or ranked.

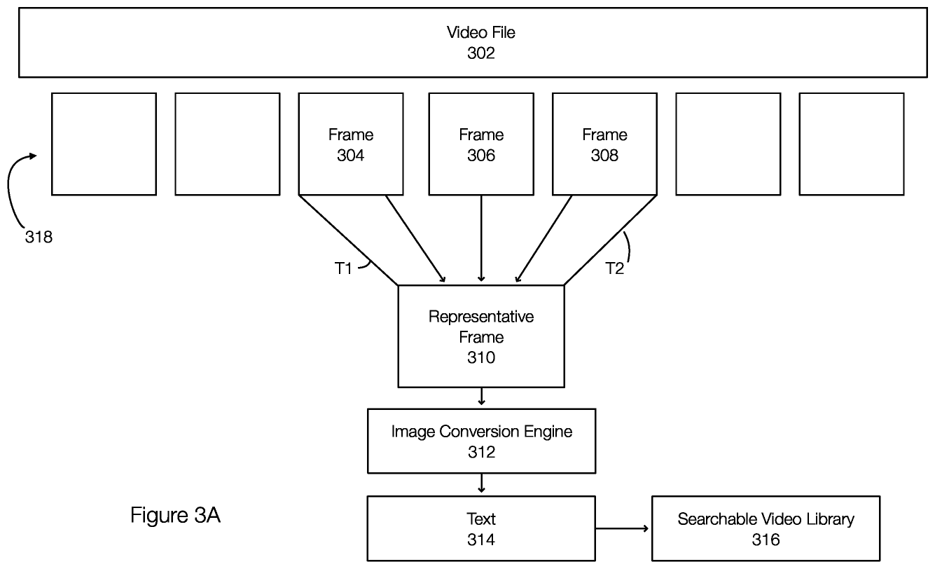

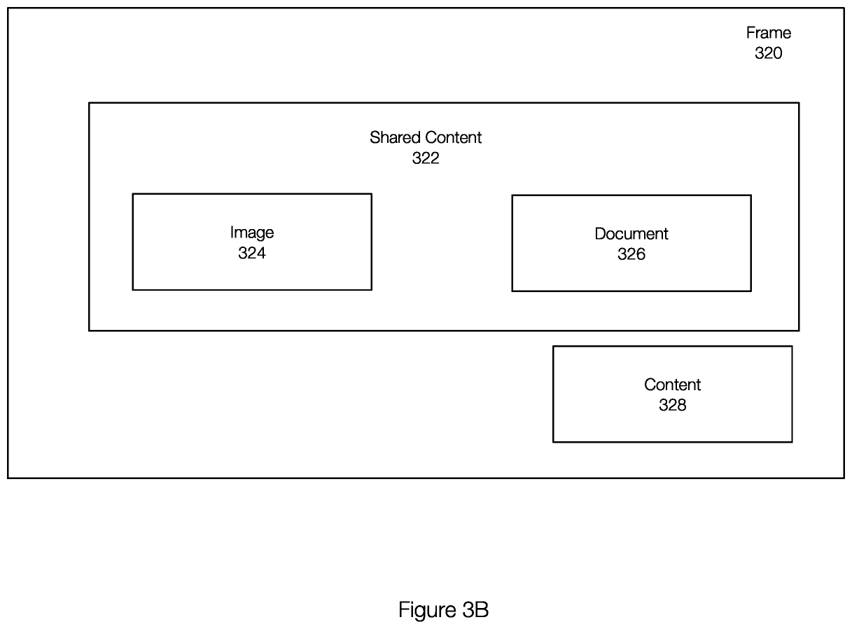

FIG. 3A discloses aspects of processing an image or video portion of a video file. In FIG. 3A, a video file 302 or the image portion thereof is being processed to generate text that is searchable. Initially, the frames 318 of the video file 302 are extracted. Next, the frames 318 are processed to find representative frames and their associated start and end times, which are examples of timestamps.

More specifically, finding representative frames may include identifying frames that are similar or semi-identical. A similarity threshold may be used to determine whether one frame is similar to another frame. The similarity threshold may be 0.8 by way of example.

FIG. 3B illustrates an example of an image or frame that is representative of multiple frames in a video file. In this example, the representative frame 320 (an example of the representative frame 310) includes shared content 322. In an online meeting, content may be shared with all participants in the meeting. The shared content 322 may include an image 324 and a document 326. The document 326 is representative of, by way of example only, a slide, header, document, presentation slide, or the like or combination thereof. However, the shared content 322 is represented as an image. The text is extracted, for example, using object recognition and OCR.

For example, if the meeting relates to bear habitat, the image 324 may be an image of a bear and the document 326 may include text such as a description of habitat, population information, or the like. As previously stated, the document 326 is in image form and not in text form. The video 328 may include the speaker.

When generating the representative frame 320 from the underlying video file, many frames may include the shared content 322 and the shared content 322 may not change for some period of time. Thus multiple frames of the video file include the shared content 322. The content 328, which may contain a video of the current speaker, may change from one frame to the next. These changes may correspond to movement of the speaker. Alternatively, the change may relate to a change in the active speaker.

Because these frames all satisfy the similarity threshold, these frames in the video file can be consolidated into and represented by the representative frame 320. The start time or timestamp in the video file may correspond to a time of a frame just prior to showing the shared content 322. The end time may correspond to a time to timestamp when the shared content 322 is removed.

If the document 326 is a document that periodically changes (e.g., goes to a new page), this may introduce sufficient dissimilarity such that frames showing a first page of the document 326 correspond to a first representative frame and such that frames showing a second page of the document 326 correspond to a second representative frame. In other words, one of the frames associated with the second representative frame is not sufficiently similar to one of the frames associated with the first representative frame.

Returning to FIG. 3A, the frames 304, 306, and 308 are determined to be sufficiently similar to each other. Similarity (e.g., is a sufficient percentage of pixels unchanged between two or more frames) can be determined by comparing each frame to one other frame, to more than one frame, or the like. A representative frame 310 is thus generated from the frames 304, 306, and 308. In one example, the representative frame 310 is simply one of the frames 304, 306, and 308. Alternatively, the content that is the same across multiple frames is included in the representative frame 310. The start time T1 may be a time when the shared content 320 first appeared in the video and the end time T2 may be a time when the shared content 320 disappeared from the video.

Once a representative frame 310 is generated or selected, the image conversion engine 312 processes the representative frame 310. This may include OCR of the document 326 and object recognition of the image 324. In one example, the text in an image may be recognized using OCR. The entire frame may be processed to identify text that can be recognized. The figures in the image 324 may be recognized using image recognition with pre-trained/trained models (e.g., https://cloud.google.com/vision). The entire frame may be analyzed for objects that can be recognized. The image conversion engine 312, in any event, generates text 314 for the representative frame that can be stored in the searchable video library 316.

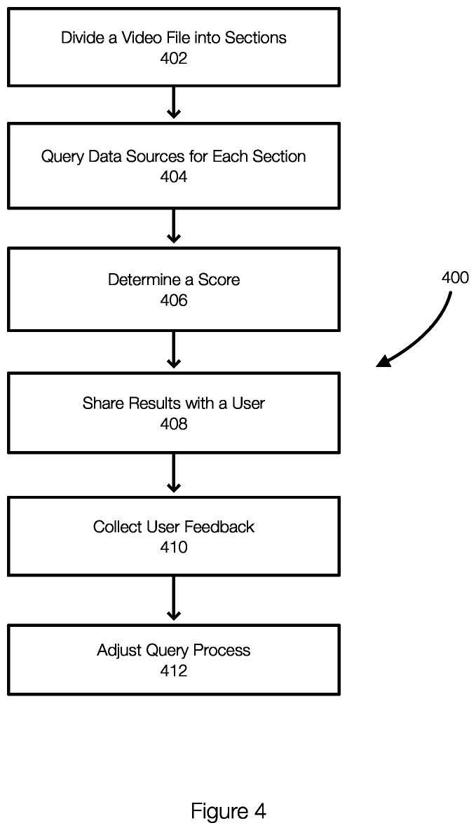

FIG. 4 discloses aspects of performing a search, which may include natural language processing, in the context of a searchable video library. Embodiments of the invention may include portions or aspects of the method 400. For example, the elements related to generating feedback may not always be performed when searching the video library. Further, a search may be performed when the video files have already been processed or segmented.

In one example, the explorer engine is configured to perform a search in the searchable video library and generate results. In one example, embodiments of the invention generate more accurate and relevant results by searching two sources (e.g., the transcript database 206 and the image text database 214, which may be incorporated into a single database). The NLP engine may be configured to learn optimal weights for the transcript database and the image text database or portions thereof such that the results from these two sources can be combined and sorted.

When segmenting or dividing a video file, this allows the semantic search to be performed against two sources that correspond, usually, to the same portion of a video file. This may increase the likelihood that a search will return the results desired by the user. Further, these sources can be weighted in different manners.

More specifically, the content of each video can differ. A first video may have a substantial amount of shared content in the form of shared slides, documents, images, and the like. A second video, in contrast, may only include speech data corresponding to discussions that occurred in the meeting. In some examples, a feedback loop may be used to adjust the manner in which the data sources or portions thereof are weighted or contribute to the results and such that the NLP engine can learn customized and optimal weights.

The method 400 in FIG. 4 may include dividing 402 a video into sections or segments. The sections may each have a theme. Dividing a video file or portions thereof into sections may include applying similarity techniques to the transcript data and to the image text data. For example, Doc2Vec or Word2Vec may be used to embed the text and calculate similarity between paragraphs or sentences. With regard to the image portion of a video file, finding a meaningful change in the frames may indicate that a new section has started. Using these similarity-based techniques, a video file can be divided into sections. The sections generated from the audio portion may or may not align with the sections generated from the image portion of the video file. These discrepancies, however, can be accounted for when identifying a relevant clip. Dividing the video file into sections may be performed as part of the processing performed prior to performing a query.

Next, the data sources (the transcript or transcript database and the image data or image text database) for each section are queried 404. In one example, each section may be a block of text. A pretrained model such as BERT (https://en.widipedia.org/wiki/BERT (language model or NLP engine) may be used. The output of a model, by way of example only, may include an answer and two associated p-values. BERT is an example of a machine learning model trained to understand the input semantically. This facilitates a semantic search of the text data associated with and derived from the video files being searched.

When each section is a block of text, the block of text can be compared to the query. Thus, a language model can determine a similarity between a block of text in a section of the video and the query. This effectively allows the relevant blocks of text and thus relevant video sections to be identified. The sections that are most similar to the query may be returned. Further, because the text is indexed, specific locations or portions of the video file can be identified.

In one example, when querying 404 the data sources, an answer and p values may be returned for each source. For each answer returned from the query, a timestamp is extracted. The p values essentially represent the relevance or significance of the answer or represent confidence in the similarity between the query and the video library text.

Next, a score is determined 406 for each data source. A score is calculated based on the p-values associated to each answer. The scores are merged by multiplying the weights of the data sources with the answers. If an output or result of the search (e.g., a timestamp in a video file) was found by or in only one data source, then the weight of the second data source is multiplied by zero. This ensures that if the same answer is obtained from both the audio and image data, the score is higher. The answers may then be sorted by their merged scores.

Next, the results are shared 408 with a user. The results may include a list of video files and locations. The results may also include some of the text associated with the video file. Feedback is collected 410 based on which of the results is selected by the user. For example, if the top five results are presented to the user and the user does not choose the top result as the correct result, the weights are adjusted such that the right result (as identified by the user) will be the top result. This feedback allows the query process to be adjusted 412, which may include optimizing the weights associated with the sources and/or sections of the data sources.

Embodiments of the invention combine image and voice data (speech) to maximize the ability to capture the meaning and themes. The combined usage of image and voice data maximize the ability to capture the meaning and themes in video data or video files. Analyzing the content included in voice and image in parallel is used to provide accurate and quality results when searching video files conceptually. Embodiments of the invention allow video files to be searched semantically.

Embodiments of the invention allow a user to query multiple video files in parallel. As previously described, the query can be flexible and allows the user to express a concept or detail without being required to use the same wording that was used in the online meeting. Further, embodiments of the invention address a professional need that improves productivity and saves time. Embodiments of the invention make the content of video files such as online meeting recordings to be efficiently and easily accessible and searchable or explorable. Embodiments of the invention provide increased visibility into the concepts and discussions occurring in, for example, online meetings.

Capturing online meetings using embodiments of the invention in an accessible and searchable manner also allows a knowledge graph to be built, which represents a collection of interlinked descriptions. This allows details in one video file, for example, to be linked to similar details in another video file.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients or computing devices that are capable of collecting, modifying, and creating, data. As such, a particular client may employ, or otherwise be associated with, one or more instances of each of one or more applications that perform such operations with respect to data. Such clients may comprise physical machines, or virtual machines (VM)

Particularly, devices or clients in the operating environment may take the form of software, physical machines, or VMs, or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines or virtual machines (VM), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures, and provides the functionality of a physical computer. A VM implementation may comprise, or at least involve the use of, hardware and/or software. An image of a VM may take the form of a .VMX file and one or more .VMDK files (VM hard disks) for example. Embodiments of the invention may also operate in containerized environments and may be implemented as containers.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

It is noted with respect to any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

Following are some further example embodiments of the invention. These are presented only by way of example and are not intended to limit the scope of the invention in any way.

Embodiment 1. A method, comprising: receiving a query from a user, semantically searching a video library based on the query, wherein the video library includes a first source associated with audio of a video file and a second source associated with images of the video file, and returning a result from the video library based on the query, the result identifying the video file and a location in the video file.

Embodiment 2. The method of embodiment 1, further comprising processing the video file by converting the audio to the first text that is stored in the first source and by converting images to the second text that is stored in the second source, wherein the audio includes speech and the images includes shared content including at least one of a document, a slide, a header, or an object.

Embodiment 3. The method of embodiment 1 and/or 2, further comprising processing the images by grouping the images into sets of frames and identifying a representative frame for each set of frames.

Embodiment 4. The method of embodiment 1, 2, and/or 3, wherein for each set of frames, each frame satisfies a similarity threshold with respect the other frames in the set.

Embodiment 5. The method of embodiment 1, 2, 3, and/or 4, further comprising dividing the video file into sections, each section having a theme and each segment associated with a portion of the first text and a portion of the second text.

Embodiment 6. The method of embodiment 1, 2, 3, 4, and/or 5, further comprising querying the first source and the second source for each section and determining a score for each section.

Embodiment 7. The method of embodiment 1, 2, 3, 4, 5, and/or 6, wherein the video library is associated with multiple video files, further comprising collecting user feedback based on the results, the results including a ranked list of videos and associated locations, further comprising adjusting weights associated with the first source and the second source based on the feedback.

Embodiment 8. The method of embodiment 1, 2, 3, 4, 5, 6, and/or 7, wherein the result includes a list of video files, further comprising performing feedback when a video file selected by a user is not at a top of the list, wherein performing feedback includes adjusting weights of the first source and the second source such that the video file selected by the user would be at the top of the list.

Embodiment 9. The method of embodiment 1, 2, 3, 4, 5, 6, 7, and/or 8, further comprising converting the audio to text and

Embodiment 10. The method of embodiment 1, 2, 3, 4, 5, 6, 7, 8, and/or 9, further comprising scoring the result with a score, wherein the score includes a first weighted score from the first course and a second weighted score from the second source.

Embodiment 11. A method for performing any of the operations, methods, or processes, or any portion of any of these or any combination thereof, disclosed herein.

Embodiment 12. A non-transitory storage medium having stored therein instructions that are executable by one or more hardware processors to perform operations comprising the operations of any one or more of embodiments 1 through 11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

Any one or more of the entities disclosed, or implied, by the Figures and/or elsewhere herein, may take the form of, or include, or be implemented on, or hosted by, a physical computing device. As well, where any of the aforementioned elements comprise or consist of a virtual machine (VM), that VM may constitute a virtualization of any combination of the physical components.

In the example, the physical computing device includes a memory which may include one, some, or all, of random access memory (RAM), non-volatile memory (NVM) such as NVRAM for example, read-only memory (ROM), and persistent memory, one or more hardware processors, non-transitory storage media, UI device, and data storage. One or more of the memory components of the physical computing device may take the form of soli-state device (SSD) storage. As well, one or more applications may be provided that comprise instructions executable by one or more hardware processors to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method, comprising:
receiving a query from a user;
semantically searching a video library based on the query, wherein the video library includes a first source associated with audio of a video file and a second source associated with images of the video file; and
returning a result from the video library based on the query, the first source, and the second source, the result identifying the video file and a location in the video file.

2. The method of claim 1, further comprising processing the video file by converting the audio to a first text that is stored in the first source and by converting images to a second text that is stored in the second source, wherein the audio includes speech and the images includes shared content including at least one of a document, a slide, a header, or an object.

3. The method of claim 2, further comprising processing the images by grouping the images into sets of frames and identifying a representative frame for each set of frames.

4. The method of claim 3, wherein for each set of frames, each frame satisfies a similarity threshold with respect to other frames in the set of frames.

5. The method of claim 2, further comprising dividing the video file into sections and segments, each section having a theme and each segment associated with a portion of the first text and a portion of the second text.

6. The method of claim 5, further comprising querying the first source and the second source for each section and determining a score for each section.

7. The method of claim 6, wherein the video library is associated with multiple video files, further comprising collecting user feedback based on results of querying the first source and the second source, the results including a ranked list of videos and associated locations, further comprising adjusting weights associated with the first source and the second source based on the feedback.

8. The method of claim 7, wherein the result includes a list of video files, further comprising performing feedback when a video file selected by a user is not at a top of the list, wherein performing feedback includes adjusting weights of the first source and the second source such that the video file selected by the user would be at the top of the list.

9. The method of claim 1, further comprising converting the audio to text.

10. The method of claim 1, further comprising scoring the result with a score, wherein the score includes a first weighted score from the first source and a second weighted score from the second source.

11. A non-transitory storage medium having stored therein instructions that are executable by one or more hardware processors to perform operations comprising:
receiving a query from a user;
semantically searching a video library based on the query, wherein the video library includes a first source associated with audio of a video file and a second source associated with images of the video file; and
returning a result from the video library based on the query, the first source, and the second source, the result identifying the video file and a location in the video file.

12. The non-transitory storage medium of claim 11, further comprising processing the video file by converting the audio to a first text that is stored in the first source and by converting images to a second text that is stored in the second source, wherein the audio includes speech and the images includes shared content including at least one of a document, a slide, a header, or an object.

13. The non-transitory storage medium of claim 12, further comprising processing the images by grouping the images into sets of frames and identifying a representative frame for each set of frames.

14. The non-transitory storage medium of claim 13, wherein for each set of frames, each frame satisfies a similarity threshold with respect to other frames in the set of frames.

15. The non-transitory storage medium of claim 12, further comprising dividing the video file into sections and segments, each section having a theme and each segment associated with a portion of the first text and a portion of the second text.

16. The non-transitory storage medium of claim 15, further comprising querying the first source and the second source for each section and determining a score for each section.

17. The non-transitory storage medium of claim 16, wherein the video library is associated with multiple video files, further comprising collecting user feedback based on results of querying the first source and the second source, the results including a ranked list of videos and associated locations, further comprising adjusting weights associated with the first source and the second source based on the feedback.

18. The non-transitory storage medium of claim 17, wherein the result includes a list of video files, further comprising performing feedback when a video file selected by a user is not at a top of the list, wherein performing feedback includes adjusting weights of the first source and the second source such that the video file selected by the user would be at the top of the list.

19. The non-transitory storage medium of claim 11, further comprising converting the audio to text.

20. The non-transitory storage medium of claim 11, further comprising scoring the result with a score, wherein the score includes a first weighted score from the first source and a second weighted score from the second source.
